(19) United States
(12) Patent Application Publication
(10) Pub. No.: US 2015/0018204 A1
(43) Pub. Date: Jan. 15, 2015

(54) Minimizing Washcoat Adhesion Loss of Zero-PGM Catalyst Coated on Metallic Substrate

(71) Applicants: Zahra Nazarpoor, Camarillo, CA (US); Sen Kitazumi, Oxnard, CA (US); Johnny T. Ngo, Oxnard, CA (US)

(72) Inventors: Zahra Nazarpoor, Camarillo, CA (US); Sen Kitazumi, Oxnard, CA (US); Johnny T. Ngo, Oxnard, CA (US)

(73) Assignee: CDTI, Ventura, CA (US)

(21) Appl. No.: 13/941,022

(22) Filed: Jul. 12, 2013

(51) Int. Cl. B01J 23/83; B01J 23/72

(52) U.S. Cl. CPC B01J 23/83; B01J 23/72
USPC 502/304; 502/300; 502/345; 502/355

(57) ABSTRACT

Solutions to the problem of washcoat and/or overcoat adhesion loss of ZPGM catalyst on metallic substrates are disclosed. Present disclosure provides an enhanced process for improving WCA to metallic substrates of ZPGM catalyst systems. Reduction of WCA loss and improved catalyst activity may be enabled by the selection of processing parameters determined from variation of rheological properties by the solid content of the overcoat slurry and variation of the overcoat slurry particle size distribution to produce desirable homogeneity, specific loading, and adherence of the coating on metallic substrates. Processing parameters may be applied to a plurality of metallic substrates of different geometries and cell densities.

### CROSS-REFERENCE TO RELATED APPLICATIONS

N/A

### BACKGROUND

1. Technical Field

The present disclosure relates generally to ZPGM catalyst systems, and, more particularly, to a process to optimize adhesion of washcoats/overcoats and integrity of Zero-PGM catalysts on metallic substrates.

2. Background Information

Although the most popular substrates may be made from ceramic structures such as cordierite and obtained by extrusion, these substrates have limitations that associated to the flow model may originate a non-homogeneous radial thermal profile. Ceramic substrates may dominate the car market, primarily because they are mass-produced and therefore less costly. However, metallic substrates may offer the industry of catalyst systems significant advantages.

The substrate of a catalytic system fulfills an important role in supporting the catalytic material and may be capable of withstanding some extremely arduous conditions. Operating temperatures may be in excess of 1000° C. and the substrate may also be exposed to fast moving, corrosive exhaust gases, rapid changes in temperature and pressure, and external factors such as shocks and vibration.

Nowadays, with more rigorous regulations forcing catalyst manufacturers to devise new technologies to ensure a high catalytic activity, a major problem in the manufacturing of catalyst systems may be achieving the required adhesion of a washcoat and/or overcoat to a metallic substrate. Coating on metallic substrates may be affected by type of materials used and other factors, which include, but are not limited to, substrate geometry and size, substrate cell density, washcoat (WC) and overcoat (OC) particle size and distribution, additive properties, amounts of WC and OC loadings, ratio of alumina to oxygen storage material (OSM), and treatment condition.

For the foregoing, although metallic substrates may be the appropriate choice for motorcycle catalysts and other catalyst system applications as shown by the advantages offered by metallic substrates, there may be a need for improvements in the usage of metallic substrates in Zero-PGM catalyst systems with lower loss of adhesion, strong WC/OC layers, better integrity of WC and OC, and improved catalyst performance.

### SUMMARY

The present disclosure may provide solutions to the problem of washcoat and/or overcoat adhesion (WCA) loss on metallic substrates, as well as a method for optimizing WCA to metallic substrates for ZPGM catalyst systems using a set of control parameters which may have a direct influence on WCA. Reduction of WCA loss may also improve the ZPGM catalyst system performance and activity.

According to embodiments in present disclosure, compositions of ZPGM catalyst systems may include any suitable combination of a metallic substrate, a washcoat, and an overcoat which includes copper (Cu), cerium (Ce), and other metal combinations. Catalyst samples with metallic substrate of varied geometry and cells per square inch (CPSI) may be prepared using any suitable synthesis method as known in current art.

In other embodiments of the present disclosure, when catalyst samples that may be prepared accordingly may not provide a desirable level of % of WCA and catalyst activity. WCA loss may be controlled by varying the rheology of OC slurry by changing the percentage of solids in the OC. Additionally, variations of the particle size of OC slurry may provide significant data of the effect on WCA loss, specifically on the cohesion between WC particles and OC particles, which may be caused by varying the OC particle size distribution. Catalyst samples that may be prepared varying these processing parameters may be subjected to a plurality of tests, including, but not limited to, back pressure testing, verification and inspection of coating uniformity, characterization by XRD analysis to calculate dispersion of active base metal, and testing the catalyst activity in exhaust lean condition. This enhanced processing for Zero-PGM catalyst sample may provide a final product with the desired optimal characteristics of enhanced WCA and optimal catalyst performance.

Results in reduction of WCA loss according to the variations of the OC rheology and OC particle size distribution may be registered for application to other metallic substrates geometries, sizes, and cell densities. The process of WCA loss control for other metallic substrates may use the values of the parameters, which in this final processing may produce the optimal reduction in WCA loss and enhanced catalyst activity and performance.

Numerous objects and advantages of the present disclosure may be apparent from the detailed description that follows and the drawings which illustrate the embodiments of the present disclosure, and which are incorporated herein by reference.

### BRIEF DESCRIPTION OF THE DRAWINGS

Non-limiting embodiments of the present disclosure are described by way of example with reference to the accompanying figures which are schematic and are not intended to be drawn to scale. Unless indicated as representing the background art, the figures represent aspects of the disclosure.

FIG. 1 presents WCA loss comparison for catalyst samples on a D33 mm×L40 mm, 200 CPSI metallic substrate with variations of rheology of OC slurry and OC particle size, d₅₀, according to an embodiment.

FIG. 2 presents verification of coating uniformity for D33 mm×L40 mm, 200 CPSI metallic substrate with WC loading of 80 g/L and OC loading of 120 g/L, according to an embodiment.

FIG. 3 depicts visual inspection of cross section of catalyst samples on a D33 mm×L40 mm, 200 CPSI metallic substrate with WC loading of 80 g/L and OC loading of 120 G/L, according to an embodiment.

FIG. 4 depicts XRD analysis for ZPGM catalyst samples on a D33 mm×L40 mm, 200 CPSI metallic substrate, with WC loading of 80 g/L and OC loading of 120 g/L, according to an embodiment.

FIG. 5 illustrates verification of % WCA loss for fresh and aged catalyst samples on a D33 mm×L40 mm, 200 CPSI metallic substrate with WC loading of 80 g/L and OC loading of 120 g/L, according to an embodiment.

FIGS. 6A and B illustrates catalyst activity profiles in CO and HC conversion for fresh catalyst samples on a D33 mm×L40 mm, 200 CPSI metallic substrate with WC loading of 80 g/L and OC loading of 120 g/L, according to an embodiment. FIG. 6A shows catalyst activity profile in CO conversion and FIG. 6B shows catalyst activity profile in HC conversion.

### DETAILED DESCRIPTION

In the following detailed description, reference is made to the accompanying drawings, which form a part hereof. In the drawings, which are not to scale or to proportion, similar symbols typically identify similar components, unless context dictates otherwise. The illustrative embodiments described in the detailed description, drawings and claims, are not meant to be limiting. Other embodiments may be used and/or and other changes may be made without departing from the spirit or scope of the present disclosure.

### Definitions

As used here, the following terms have the following definitions:

“Substrate” may refer to any material of any shape or configuration that yields a sufficient surface area for depositing a washcoat and/or overcoat.

“Washcoat” may refer to at least one coating including at least one oxide solid that may be deposited on a substrate.

“Overcoat” may refer to at least one coating that may be deposited on at least one washcoat layer.

“Catalyst” may refer to one or more materials that may be of use in the conversion of one or more other materials.

“Zero platinum group (ZPGM) catalyst” may refer to a catalyst completely or substantially free of platinum group metals.

“Co-precipitation” may refer to the carrying down by a precipitate of substances normally soluble under the conditions employed.

“Milling” may refer to the operation of breaking a solid material into a desired grain or particle size.

“Carrier material oxide (CMO)” may refer to support materials used for providing a surface for at least one catalyst.

“Oxygen storage material (OSM)” may refer to a material able to take up oxygen from oxygen rich streams and able to release oxygen to oxygen deficient streams.

“Treating,” “treated,” or “treatment” may refer to drying, firing, heating, evaporating, calcining, or combinations thereof.

“Calcination” may refer to a thermal treatment process applied to solid materials, in presence of air, to bring about a thermal decomposition, phase transition, or removal of a volatile fraction at temperatures below the melting point of the solid materials.

“Conversion” may refer to the chemical alteration of at least one material into one or more other materials.

“d₅₀” may refer to the average size of 50% of particles distributed in a washcoat.

“T50” may refer to the temperature at which 50% of a material is converted.

### DESCRIPTION OF THE DRAWINGS

Various example embodiments of the present disclosure are described more fully with reference to the accompanying drawings in which some example embodiments of the present disclosure are shown. Illustrative embodiments of the present disclosure are disclosed here. However, specific structural and functional details disclosed here are merely representative for purposes of describing example embodiments of the present disclosure. This disclosure however, may be embodied in many alternate forms and should not be construed as limited to only the embodiments set forth in the present disclosure.

ZPGM Catalyst System Configuration and Composition

According to embodiments in the present disclosure, a ZPGM catalyst system may include at least a metallic substrate, a washcoat (WC), and an overcoat (OC). WC and OC may include at least one ZPGM catalyst. WC may be formed on a metallic substrate by suspending the oxide solids in water to form an aqueous slurry and depositing the aqueous slurry on substrate as washcoat. Subsequently, in order to form ZPGM catalyst system, OC may be deposited on WC.

Metallic Substrates

Metallic substrates may be in the form of beads or pellets or of any suitable form. The beads or pellets may be formed from any suitable material such as alumina, silica alumina, silica, titania, mixtures thereof, or any suitable material. If substrate is a metal honeycomb, the metal may be a heat-resistant base metal alloy, particularly an alloy in which iron is a substantial or major component. The surface of the metal substrate may be oxidized at temperatures higher than 1000° C. to improve the corrosion resistance of the alloy by forming an oxide layer on the surface of the alloy.

Metallic substrate may be a monolithic carrier having a plurality of fine, parallel flow passages extending through the monolith. The passages may be of any suitable cross-sectional shape and/or size. The passages may be trapezoidal, rectangular, square, sinusoidal, hexagonal, oval, or circular, although other shapes may be suitable. The monolith may contain from about 9 to about 1,200 or more gas inlet openings or passages per square inch of cross section, although fewer passages may be used. Metallic substrate may be used with different dimension and cell density (CPSI).

WC Material Composition and Preparation

According to embodiments in the present disclosure, a WC may free of ZPGM transition metal catalyst. A WC may include support oxides material referred to as carrier material oxides (CMO) which may include aluminum oxide, doped aluminum oxide, spinel, delafossite, lyonsite, garnet, perovksite, pyrochlore, doped ceria, fluorite, zirconium oxide, doped zirconia, titanium oxide, tin oxide, silicon dioxide, zeolite, and mixtures thereof. According to embodiments in present disclosure, the support oxide may preferably include any type of alumina or doped alumina. WC may include oxygen storage materials (OSM), such as cerium, zirconium, lanthanum, yttrium, lanthanides, actinides, and mixtures thereof. The OSM and the alumina may be present in WC in a ratio between 40% to about 60% by weight.

In some embodiments, WC may also include other components such as acid or base solutions or various salts or organic compounds that may be added to adjust rheology of the WC slurry. These compounds may be added to enhance the adhesion of washcoat to the metallic substrate. Compounds that may be used to adjust the rheology may include ammonium hydroxide, aluminum hydroxide, acetic acid, citric acid, tetraethyl ammonium hydroxide, other tetralkyl ammonium salts, ammonium acetate, ammonium citrate, glycerol, commercial polymers such as polyethylene glycol, polyvinyl alcohol, amongst others.

Preparation of WC may be achieved at room temperature. WC may be prepared by milling powder forms including WC materials in any suitable mill such as vertical or horizontal mills. WC materials may be initially mixed with water or any suitable organic solvent. Suitable organic solvents may include ethanol, and diethyl ether, carbon tetrachloride, and trichloroethylene, amongst others. Powder WC materials may include ZPGM transition metal catalyst and CMOs, as previously described. Subsequently, mixed WC materials may be milled down into smaller particle sizes during a period of time from about 10 minutes to about 10 hours, depending on the batch size, kind of material and particle size desired. According to embodiments in the present disclosure WC particle size of the WC slurry may be of about 4 μm to about 10 μm in order to get uniform distribution of WC particles.

The milled WC, in the form of aqueous slurry may be deposited on a metallic substrate employing vacuum dosing and coating systems and may be subsequently treated. A plurality of deposition methods may be employed, such as placing, adhering, curing, coating, spraying, dipping, painting, or any known process for coating a film on at least one metallic substrate. If the metallic substrate is a monolithic carrier with parallel flow passages, WC may be formed on the walls of the passages. Various capacities of WC loadings in the present disclosure may be coated on the metallic substrate. The WC loading may vary from 60 g/L to 200 g/L.

After depositing WC on the metallic substrate, according to embodiments in the present disclosure WC may be treated by drying and heating. For drying the WC, air knife drying systems may be employed. Heat treatments may be performed using commercially-available firing (calcination) systems. The treatment may take from about 2 hours to about 6 hours, preferably about 4 hours, and at a temperature of about 300° C. to about 700° C., preferably about 550° C. After WC is treated and cooled at room temperature, OC may be deposited on WC.

OC Material Composition and Preparation

The overcoat may include ZPGM transition metal catalysts, including at least one or more transition metals, and at least one rare earth metal, or mixture thereof that are completely free of platinum group metals. The transition metals may be a single transition metal, or a mixture of transition metals which may include chromium, manganese, iron, cobalt, nickel, niobium, molybdenum, tungsten, and Cu. In the present disclosure, preferably, the ZPGM transition metal may be Cu. Preferred rare earth metal may be cerium (Ce). The total amount of Cu catalyst included in OC may be of about 5% by weight to about 50% by weight of the total catalyst weight, preferably of about 10% to 16% by weight. Furthermore, the total amount of Ce catalyst included in OC may be of about 5% by weight to about 50% by weight of the total catalyst weight, preferably of about 12% to 20% by weight. Different Cu and Ce salts such as nitrate, acetate or chloride may be used as ZPGM catalysts precursors.

OC may include CMOs. CMOs may include aluminum oxide, doped aluminum oxide, spinel, delafossite, lyonsite, garnet, perovksite, pyroclore, doped ceria, fluorite, zirconium oxide, doped zirconia, titanium oxide, tin oxide, silicon dioxide, zeolite, and mixtures thereof. According to embodiments in present disclosure, CMO in the OC may be any type of alumina or doped alumina. The doped aluminum oxide in OC may include one or more selected from the group consisting of lanthanum, yttrium, lanthanides and mixtures thereof. CMO may be present in OC in a ratio between 40% to about 60% by weight.

Additionally, according to embodiments in the present disclosure, OC may also include OSM. Amount of OSM may be of about 10% to about 90% by weight, preferably of about 40% to about 75% by weight. The weight of OSM is on the basis of the oxides. The OSM may include at least one oxide selected from the group consisting of zirconium, lanthanum, yttrium, lanthanides, actinides, Ce, and mixtures thereof. OSM in the present OC may be a mixture of ceria and zirconia; more suitable, a mixture of (1) ceria, zirconia, and lanthanum or (2) ceria, zirconia, neodymium, and praseodymium, and most suitable, a mixture of cerium, zirconium, and neodymium. OSM may be present in OC in a ratio between 40% to about 60% by weight. Cu and Ce in OC are present in about 5% to about 50% by weight or from about 10% to 16% by weight of Cu and 12% to 20% by weight of Ce.

The OC may be prepared by co-precipitation synthesis method. Preparation may begin by mixing the appropriate amount of Cu and Ce salts, such as nitrate, acetate or chloride solutions, where the suitable Cu loadings may include loadings in a range as previously described. Subsequently, the Cu—Ce solution is mixed with the slurry of CMO support. Co-precipitation of the OC may include the addition of appropriate amount of one or more of NaOH solution, Na₂CO₃ solution, and ammonium hydroxide (NH₄OH) solution. The pH of OC slurry may be adjusted to a desired value by adjusting the rheology of the aqueous OC slurry adding acid or base solutions or various salts or organic compounds, such as, ammonium hydroxide, aluminum hydroxide, acetic acid, citric acid, tetraethyl ammonium hydroxide, other tetralkyl ammonium salts, ammonium acetate, ammonium citrate, glycerol, commercial polymers such as polyethylene glycol, polyvinyl alcohol, and other suitable compounds. The OC slurry may be aged for a period of time of about 12 to 24 hours at room temperature. This precipitation may be formed over a slurry including at least one suitable CMO, or any number of additional suitable CMOs, and may include one or more suitable OSMs as previously described. Then OC may be deposited on substrate previously coated with WC by employing suitable deposition techniques such as vacuum dosing, amongst others. The OC loading may vary from 60 g/L to 200 g/L. OC may then be dried and treated employing suitable heat treatment techniques employing firing (calcination) systems or any other suitable treatment techniques. The ramp of heating treatment may vary. In an embodiment, treating of washcoat may not be required prior to application of overcoat. In this case, OC, WC, and metallic substrate may be treated for about 2 hours to about 6 hours, preferably about 4 hours, at a temperature of about 300° C. to about 700° C., preferably about 550° C.

Control Parameters for Optimization of Metallic Substrates in ZPGM Catalyst Systems

According to embodiments in the present disclosure, WCA loss may be controlled by a set of optimization parameters which may have an influence in WCA and performance of ZPGM catalyst systems on metallic substrates.

The optimization parameters that may be used in the present disclosure may include, but are not limited to, pH of OC slurry, which may have an influence on dispersion of Cu in the samples; addition of a binder to the OC, which may influence adhesion of the OC layer; and variation of the WC particle size, which may influence cohesion between WC particles and OC particles. Additional control parameters may be used when the initial set of parameters used in the preparation of catalyst samples may not provide a desirable level of % of WCA loss. These control optimization parameters for final processing of Zero-PGM catalyst on a metallic substrate may include, but are not limited to, variations of the OC slurry rheology, which may influence WCA when different solid percentage may be varied in the OC slurry, and variations of the OC particle size distribution, which may influence the cohesion between the WC particles and OC particles.

Catalyst samples that may be prepared varying these processing parameters may be subjected to a plurality of evaluation tests, including, but not limited to, back pressure testing, verification and inspection of coating uniformity, characterization by XRD analysis to calculate dispersion of active base metal, and catalyst activity. This enhanced processing for Zero-PGM catalysts may provide a final product with the desired optimal characteristics of enhanced WCA and optimal catalyst performance.

Results in reduction of WCA loss according to the variations of the OC rheology and OC particle size distribution may be registered for application to other metallic substrates geometries, sizes, and cell densities. The process of WCA loss control for other metallic substrates may use the values of the parameters, which in this final processing may produce the optimal reduction in WCA loss and enhanced catalyst activity and performance.

The following examples are intended to illustrate the scope of the disclosure. It is to be understood that other procedures known to those skilled in the art may alternatively be used.

### EXAMPLE #1

### Washcoat Adhesion of Zero-PGM Catalyst on a Metallic Substrate

Example #1 may illustrate processing for ZPGM catalyst on a D33 mm×L40 mm, 200 CPSI metallic substrate. Accordingly, Zero-PGM catalyst samples may be prepared to include WC target loading of 80 g/L. WC may include any type of alumina-based binder, particle size within a range of about 6.0 μm to about 7.0 μm. OC may have a target loading of 120 g/L, including any type of alumina-based binder, OSM, and Cu loading of about 10 g/L to about 15 g/L, preferably 12 g/L, and Ce loading of about 12 g/L to about 18 g/L, preferably 14.4 g/L, OC particle size within a range of about 4.5 μm to about 5.0 μm, preferably, OC particle size, d₅₀, in OC slurry of about 4.7 μm and 38% of solids in OC slurry, and pH of OC slurry within a range of about 5.0 to about 6.0. Samples may be aged at 900° C. for 4 hours under dry condition.

Verification of WCA loss may be performed using a washcoating adherence test as known in the art. The washcoat adhesion test in the present disclosure is performed by quenching the preheated substrate at 550° C. to a cold water with angle of 45 degree for 8 seconds followed by re-heating to 150° C. and then blowing cold air at 2,800 L/min. Subsequently, weight loss may be measured to calculate weight loss percentage, which is % WCA loss in present disclosure.

Testing of catalyst samples on a D33 mm×L40 mm, 200 CPSI metallic substrate, prepared using the initial set of optimization parameters, resulted in large back pressure of 1.2 kPa and thick uneven coating. The back pressure of blank substrate is 0.6 kPa. The back pressure measured by flowing 1 m³/min air through the substrate's cells at room temperature. Additionally, testing of % WCA loss resulted in 10% WCA loss level which is higher than the 3% WCA loss threshold established as acceptable range of % WCA loss to produce catalyst of enhanced WCA and optimal performance.

### EXAMPLE #2

### Effect of Varying the Rheology of OC Slurry Containing ZPGM

Example #2 may illustrate the effect of varying rheology of OC slurry for catalyst samples on a metallic substrate of a dimension of D33 mm×L40 mm, 200 CPSI. The first set of optimization parameters used in the preparation of catalyst samples as illustrated in example #1 may continue to be applied in this example illustrating the effect of varying rheology of OC slurry in WCA and catalyst performance. Thus, catalyst sample in example #2 may be prepared to include WC target loading of 80 g/L. WC may include any type of alumina-based binder, particle size within a range of about 6.0 μm to about 7.0 μm. OC may have a target loading of 120 g/L, including any type of alumina-based binder, OSM, and Cu loading of about 10 g/L to about 15 g/L, preferably 12 g/L, and Ce loading of about 12 g/L to about 18 g/L, preferably 14.4 g/L. The pH of OC slurry is within a range of about 5.0 to about 6.0 and OC particle size may vary within a range of about 3.0 μm to about 6.0 μm. Samples may be aged at 900° C. for 4 hours under dry condition.

Rheology, the percentage of solids of OC slurry, may be controlled by adjusting the amount of water in the OC slurry. In the present example, % of solids may be varied within a range of about 30% of solids to about 40% of solids. Studies in current art show that there is a correlation between % of solids in OC slurry and WCA loss for which an optimum % of solids in the OC slurry may be required to achieve % WCA loss that is in accordance to the 3% established threshold of % WCA loss. In this example, the effect of varying rheology of OC slurry containing ZPGM may be examined using a 32% of solids in the OC slurry containing ZPGM.

The resulting % of WCA loss from each variation may be compared and optimal result indicating a reduction of WCA loss may be registered relative to the established acceptable range of 3% WCA loss threshold.

### EXAMPLE #3

### Effect of OC Particle Size Distribution of OC Slurry Containing ZPGM

Example #3 may illustrate the effect of varying the OC particle size distribution of OC slurry containing ZPGM for catalyst samples on a metallic substrate of a dimension of D33 mm×L40 mm, 200 CPSI. Particle size of OC slurry may be controlled by adjustment of milling time. Catalyst samples may be prepared according to same composition as described in example #1, including WC target loading of 80 g/L. WC may include any type of alumina-based binder, particle size within a range of about 6.0 μm to about 7.0 μm. OC may have a target loading of 120 g/L, including any type of alumina-based binder, OSM, and Cu loading of about 10 g/L to about 15 g/L, preferably 12 g/L, and Ce loading of about 12 g/L to about 18 g/L, preferably 14.4 g/L. The pH of OC is within a range of about 5.0 to about 6.0 and OC particle size within a range of about 7.0 μm to about 10.0 μm. Samples may be aged at 900° C. for 4 hours under dry condition.

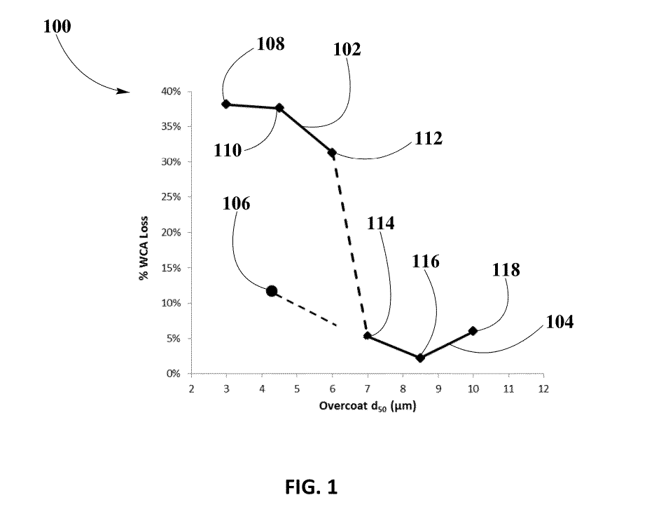

The lack of the cohesion between WC particles and OC particles may result in a high percentage of WCA loss. In this example, OC particle size, d₅₀, in OC slurry containing ZPGM may be varied to 7.0 μm, 8.5 μm, and 10.0 μm while the solid percentage of OC is adjusted to 38% for all samples. These samples can be compared to samples prepared in Example #1 with same % of solids of 38% and OC particle size of 4.7 μm. In addition, the OC particle size is varied in samples prepared in Example #2 within 3.0 μm, 4.7 μm and 6.0 μm while the % of solids of OC is adjusted at 32%. Resulting % WCA loss from variations of OC particle size may be compared, including variations of rheology in OC slurry containing ZPGM, as shown in FIG. 1. This comparison may provide desirable level of % WCA loss and optimal catalyst activity.

Verification of WCA loss may be performed using a washcoating adherence test as known in the art. The washcoat adhesion test in the present disclosure is performed by quenching the preheated substrate at 550° C. to cold water with angle of 45 degree for 8 seconds followed by re-heating to 150° C. and then blowing cold air at 2,800 L/min. Subsequently, weight loss may be measured to calculate weight loss percentage, which is % WCA loss in present disclosure. The resulting % of WCA loss from varying OC particle size may be compared and optimal result indicating a reduction of WCA loss may be registered relative to the established acceptable range of 3% WCA loss threshold.

All samples in example #1, Example #2 and example #3 may be subjected to verification of washcoat adherence in terms of % WCA loss. A profile of catalyst activity may be obtained under exhaust lean condition for sample with optimized WCA. XRD analysis may be performed to measure copper dispersion and compute CuO crystallite size for OC of sample with optimized WCA.

According to principles in the present disclosure, results of reduction of WCA loss and enhanced catalyst activity may be selected from the analysis of all variables in regards to their compound effect to optimize washcoat adhesion on metallic substrates and improve catalyst performance. The optimal results from variations of the WCA control parameters may be registered and applied to a plurality of metallic substrates in Zero-PGM catalyst systems for verification of the desired level of WCA that may provide lower WCA loss and improved catalyst activity.

Characterization of Catalyst Samples

FIG. 1 shows WCA loss comparison 100 for catalyst samples of example #1, example #2, and example #3 with variations of WCA control parameters of rheology of OC slurry and OC particle size, d₅₀, according to an embodiment. Graph section 102 depicts WCA loss for catalyst samples with 32% of solids in OC slurry containing ZPGM and graph section 104 depicts WCA loss for catalyst samples with 38% of solids in OC slurry containing ZPGM, both for OC particle size, d₅₀, in OC slurry containing ZPGM within a range of about 3.0 μm to about 10.0 μm. Data point 106 shows WCA loss for samples prepared with the initial set of optimization parameters as described in example #1 with OC solids of 38% and OC d₅₀ of 4.7 μm.

As may be seen from the analysis of WCA loss comparison 100, data point 106 shows WCA loss of about 10%, which is not a desirable percentage for WCA optimization when compared to the 3% WCA loss threshold for samples prepared with the initial set of optimization parameters as described in example #1. In graph section 102, data points 108, 110, 112 for OC particle size, d₅₀, in OC slurry containing ZPGM of about 3.0 μm, 4.7 μm and 6.0 μm, respectively, may not optimize WCA because of the high % WCA loss that result from each of the samples, within a range of about 30% to about 38%. It may be noticed from comparison of data point 106 (Example #1) with data point 110 (Example #2), having same OC particle size of 4.7 μm, that solid percentage of OC has significant effect on WCA loss. An increase of the OC solid % from 32% (data point 110) to 38% (data point 106) leads to significant decrease in WCA loss from 37.6% to 10.4% loss. It may be noticed that when OC particle size, d₅₀, is increased, % of WCA loss decreases significantly. In graph section 104, data points 114, 116, 118 for OC particle size, d₅₀, of OC slurry containing ZPGM of about 7.0 μm, 8.5 μm and 10.0 μm, respectively, is shown that with increased % of solids of 38% for graph section 104, WCA improves not only due to the increase in the OC particle size, in comparison to samples with lower % of solids in OC slurry. A decrease from about 30% to about 5% of WCA loss may be observed with a slight increase of OC particle size from about 6.0 μm to about 7.0 μm with a only a 6% increase in the percentage of solids in OC slurry from 32% to 38%. % WCA loss may reach an optimal point, as shown in data point 116 with OC d₅₀=8.5 μm for a resulting % WCA loss in the order of about 2% WCA loss, which is less than the established threshold of 3% of WCA loss. From this point up, a higher OC particle size in OC slurry may be expected that increasing % WCA loss may be resulting as may be noticed from the results in data point 118, a % WCA loss of about 5%, which is out of the acceptable range for optimal reduction of WCA loss.

These results may indicate that the level of rheology of OC slurry may affect coating. Thus, a high % of solids of OC slurry containing ZPGM may provide an even coating. A lower % of solids of OC slurry may have a drooping effect of the slurry and may create cracks at the catalyst outlet which leads to poor WCA. Additionally, a larger particle size of OC slurry may help cohesion between WC and OC and provide more contact surface between the WC particles and the OC particles.

According to principles in present disclosure, using a combination of the initial set of optimizing parameters with adjusted rheology of OC slurry of about 38% of solids in OC slurry containing ZPGM and OC particle size of about 8.5 μm may provide the desirable optimization of WCA. Optimal results in reduction of WCA loss, according to the parameter variations, may be registered for application to other metallic substrates geometries, sizes, and cell densities. The process of WCA loss control for other metallic substrates may use the values of the set of parameters that may produce the optimal reduction in WCA loss and enhanced catalyst activity and performance.

Verification of Coating Uniformity

Coating uniformity of prepared catalyst samples in example #3 with optimized WCA loss (OC d₅₀=8.5 μm and OC solid=38%) may be verified by visual inspection of cross section of coated substrate. After resin molding, the catalyst samples are cut and subsequently sanded. Visual inspections may be performed and pictures of the sections taken at the inlet and outlet sections, at the center of the cross sections. From these inspections the uniformity of coating of catalysts prepared by applying optimized process parameter may be obtained for optimization of metallic substrates according to principles in the present disclosure.

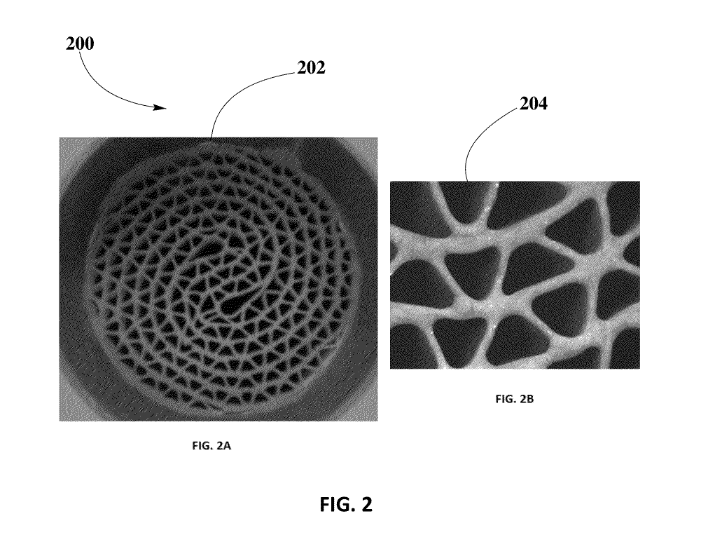

FIG. 2 presents verification of inlet coating uniformity 200 for D33 mm×L40 mm, 200 CPSI metallic substrate of example #3 according to an embodiment. FIG. 2A depicts inlet coating uniformity 202 at the inlet of catalyst sample with WC loading of 80 g/L, OC loading of 120 g/L, 38% of solids of OC slurry, and OC particle size, d₅₀, in OC slurry of about 8.5 μm. FIG. 2B depicts outlet coating uniformity 204 which is a magnified image of inlet coating of catalyst sample with WC loading of 80 g/L, OC loading of 120 g/L, 38% of solids of OC slurry, and OC particle size, d₅₀, in OC slurry of about 8.5 μm.

From inlet coating uniformity 202 and outlet coating uniformity 204 may be observed uniformity of coating at the inlet and outlet of the catalyst sample. No cracks may be observed when coating uniformity may be verified.

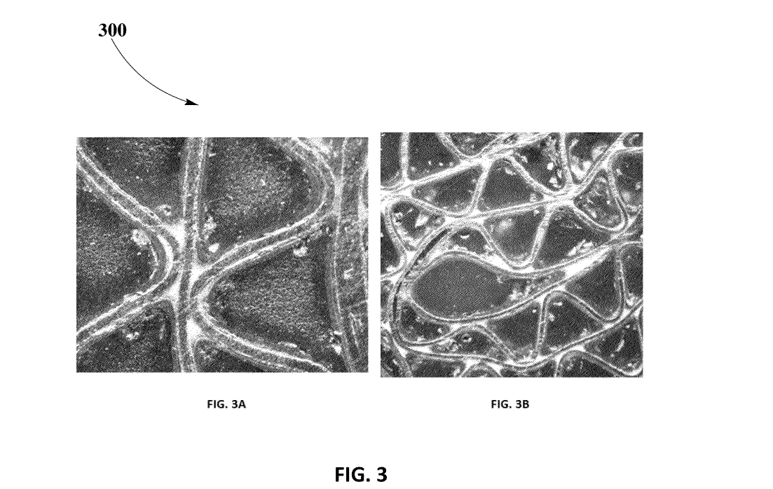

FIG. 3 illustrates visual inspection 300 of cross section of catalyst samples on a D33 mm×L40 mm, 200 CPSI metallic substrate of example #3, with WC loading of 80 g/L and OC loading of 120 g/L. Visual inspection 300 is a magnification of loading thickness for catalyst samples with 38% of solids of OC slurry and OC particle size, d₅₀, in OC slurry of about 8.5 μm. FIG. 3A and FIG. 3B show uniformity of coating at the cross sections of the center and periphery of the inlet and outlet of catalyst samples, respectively.

From visual inspection 300 may be seen that for samples with WC loading of 80 g/L, OC loading of 120 g/L, 38% of solids of OC slurry and OC particle size, d₅₀, in OC slurry of about 8.5 μm, there may be the desired penetration of OC particles through the WC layer that result in the optimum combination of parameters for lower WCA loss.

XRD Analysis and Cu Dispersion in OC Slurry

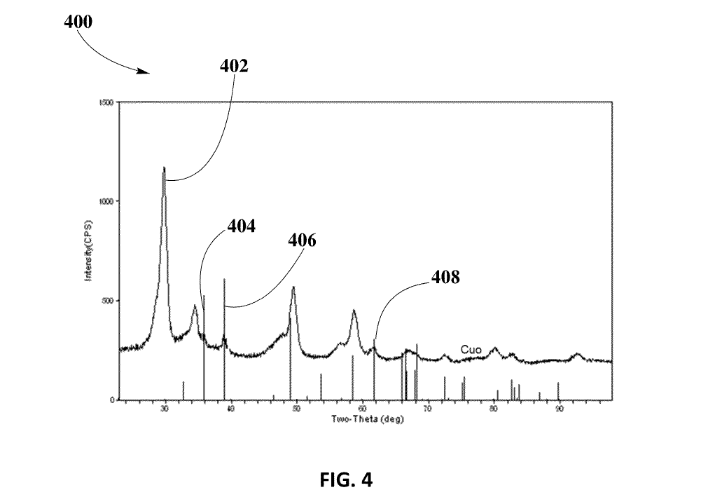

FIG. 4 presents XRD analysis 400 for catalyst samples of example #3, with 38% of solids of OC slurry and OC particle size, d₅₀, in OC slurry of about 8.5 μm on a D33 mm×L40 mm, 200 CPSI metallic substrate with WC loading of 80 g/L and OC loading of 120 g/L.

Spectrum curve 402 illustrates X-Ray diffraction peaks of powder made from OC slurry. Solid lines 404, 406, 408 depict the position of CuO diffraction peaks that may be used to compute CuO crystallite size. As may be seen in XRD analysis 400, CuO peaks of solid lines 404, 406, 408 take place at positions 2 [symbol] of about 35.7 degrees, 38.8 degrees and 61.7 degrees, respectively, of OC slurry with pH of OC slurry within a range of about 5.0 to about 6.0, solid % of 38% and particle size, d₅₀, of about 8.5 μm from optimization parameters to prepare catalyst sample of example #3. CuO peaks with higher intensity may be selected to calculate an average CuO crystallite size using the Scherrer equation as known in the art. Calculated crystallite size may be subsequently used to calculate Cu dispersion. The calculated CuO average crystallite size and Cu dispersion from XRD analysis 400 are 17 nm and 6.1% dispersion.

Verification of Washcoat Adhesion After Aging

WCA may be verified for samples prepared according to formulation of catalyst samples in example #3. Verification may be performed using a washcoating adherence test as known in the art. The washcoat adhesion test is performed by quenching the preheated substrate at 550° C. to cold water with angle of 45 degree for 8 seconds followed by re-heating to 150° C. and then blowing cold air at 2,800 L/min. Subsequently, weight loss may be measured to calculate weight loss percentage, which is % WCA loss in present disclosure.

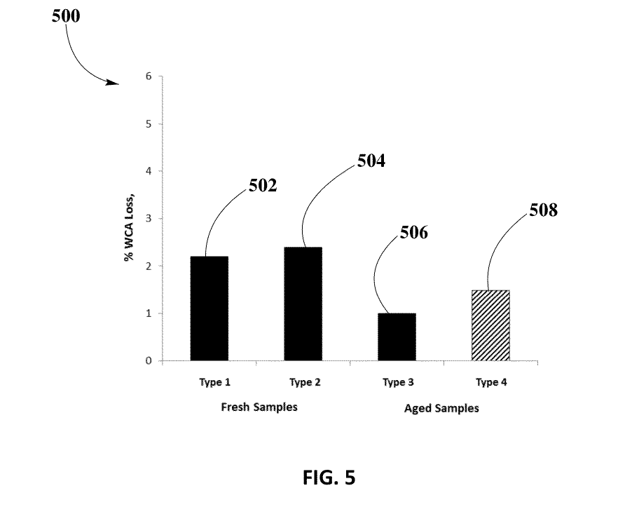

FIG. 5 illustrates verification of % WCA loss 500 for fresh and aged catalyst samples of example #3, with 38% of solids of OC slurry and OC particle size, d₅₀, in OC slurry of about 8.5 μm on a D33 mm×L40 mm, 200 CPSI metallic substrate with WC loading of 80 g/L and OC loading of 120 g/L.

For the verification of washcoat adhesion, two fresh samples with coated metallic substrates and two aged samples with coated metallic substrates may be selected to check the reproducibility of results. Catalyst samples may be identified as fresh sample Type 1, fresh sample Type 2, aged sample Type 3, and aged sample Type 4, as may be observed in FIG. 5. Accordingly, results from verification of WCA are for Type 1, solid bar 502, about 2.25% of WCA loss, for Type 2, solid bar 504, about 2.45% of WCA loss, for Type 3, solid bar 506, about 1% of WCA loss, and for Type 4, slanted line bar 508, about 1.5% of WCA loss.

As may be observed all samples show a % WCA loss that is less than the 3% WCA loss threshold that was established for optimization of WCA and enhanced catalyst performance. Samples aged at 900° C. for 4 hours under dry condition show a better WCA, presenting a lower % WCA loss than the selected fresh samples. These results also show the reproducibility of the data.

Verification of Catalyst Activity

Verification of catalyst activity of example #3, with 38% of solids of OC slurry and OC particle size, d₅₀, in OC slurry of about 8.5 μm on a D33 mm×L40 mm, 200 CPSI metallic substrate with WC loading of 80 g/L and OC loading of 120 g/L, may be performed under lean exhaust condition using a total flow of 20.1 L/min with toluene as feed hydrocarbon. The space velocity adjusted at 35,000 h⁻¹.

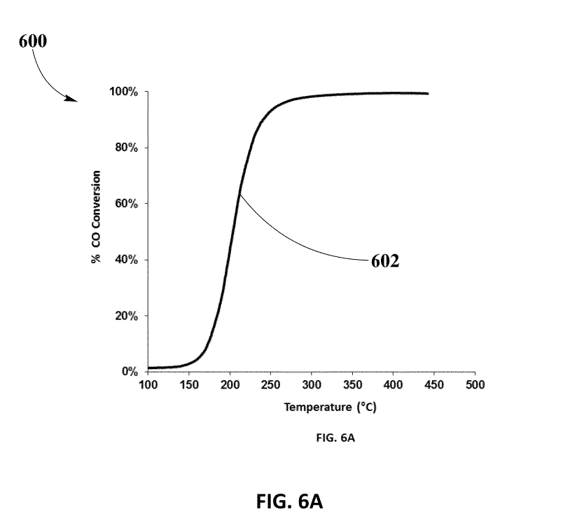

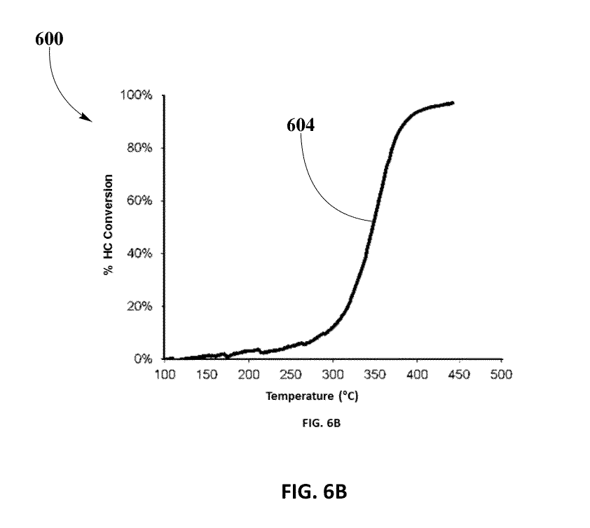

FIGS. 6A and B illustrates catalyst activity profile 600 for CO conversion for fresh catalyst samples verified according to the principles in the present disclosure. In FIG. 6A, CO conversion 602 and FIG. 6B, HC conversion 604, respectively, show catalyst activity in CO and HC conversion resulting from the third light-off test of the first fresh sample selected. As may be observed in FIG. 6A and FIG. 6B, catalyst shows a T50 of CO at 202° C., which may indicate low temperature CO conversion. Hydrocarbon conversion shows HC T50 at 343° C.

In addition to the high level of Cu dispersion shown by the samples in example #3, the low % WCA loss obtained below the 3% WCA threshold that was established for the samples, and the uniform coating of the cross section of the inspected samples, indicating the desired penetration of OC particles through the WC layer, a stable and optimized catalyst activity may indicate that use of an optimizing rheology of the OC slurry of about 38% of solids and OC particle size, d₅₀, in OC slurry of about 8.5 μm may provide, including the initial set of optimizing parameters, the optimal points required for achieving the improved WCA and enhanced catalyst performance that are desirable for a Zero-PGM catalyst on metallic substrates.

This process for optimization of Zero-PGM catalyst on metallic substrates may be applied to ZPGM catalysts on different size and cell density of metallic substrates for WCA optimization according to principles in the present disclosure.

While various aspects and embodiments have been disclosed, other aspects and embodiments may be contemplated. The various aspects and embodiments disclosed here are for purposes of illustration and are not intended to be limiting, with the true scope and spirit being indicated by the following claims.

What is claimed is:

1. A catalytic system, comprising:
at least one substrate;
a washcoat suitable for deposition on the substrate, the washcoat comprising at least one oxide solid further comprising at least one carrier metal oxide;
an overcoat suitable for deposition on the substrate, the overcoat comprising at least one ZPGM catalyst;
wherein adhesion of the washcoat is affected by one selected from the group consisting of the pH of the overcoat, at least one binder in the overcoat, ab average particle size of the overcoat, rheology of the overcoat, and combinations thereof.

2. The catalytic system of claim 1, wherein the at least one binder is about 32% to about 38% by weight of the overcoat.

3. The catalytic system of claim 2, wherein the adhesion of the washcoat is improved by about 25%.

4. The catalytic system of claim 1, wherein the average particle size of the washcoat is about 3.0 μm to about 10.0 μm.

5. The catalytic system of claim 1, wherein the average particle size of the washcoat is about 8.5 μm.

6. The catalytic system of claim 2, wherein the loss of the washcoat of less than 2%.

7. The catalytic system of claim 1, wherein the at least one ZPGM catalyst comprises one selected from the group consisting of chromium, manganese, iron, cobalt, nickel, niobium, molybdenum, tungsten, copper, and combinations thereof.

8. The catalytic system of claim 1, wherein the pH of the overcoat is about 5.0 to about 6.0.

9. The catalytic system of claim 1, wherein the rheology of the overcoat is about 30% to about 40%.

10. The catalytic system of claim 1, wherein the at least one ZPGM catalyst comprises cerium.

11. The catalytic system of claim 1, wherein the substrate comprises about 9 to about 1200 cells per square inch.

12. The catalytic system of claim 1, wherein the substrate comprises metal.

13. The catalytic system of claim 1, wherein the substrate has been heated to about 1000° C.

14. The catalytic system of claim 1, wherein the washcoat is heated for about 2 to about 6 hours.

15. The catalytic system of claim 1, wherein the washcoat is heated for about 4 hours.

16. The catalytic system of claim 1, wherein the washcoat is heated to about 300° C. to about 700° C.

17. The catalytic system of claim 1, wherein the washcoat is heated about 550° C.

18. The catalytic system of claim 1, wherein the T50 for hydrocarbon conversion is about 350° C.

19. The catalytic system of claim 1, wherein the T50 for carbon monoxide conversion is about 200° C.

20. The catalytic system of claim 1, wherein the at least one binder comprises aluminum.
